(19) United States
(12) Patent Application Publication
(10) Pub. No.: US 2007/0271476 A1
(43) Pub. Date: Nov. 22, 2007

(54) USB connection control apparatus and method and data processing apparatus and method using the same

(75) Inventor: Jeong-rok Jang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/702,096

(22) Filed: Feb. 5, 2007

(30) Foreign Application Priority Data
May 19, 2006 (KR) 2006-45110

(51) Int. Cl. G06F 1/30

(52) U.S. Cl. 713/324

(57) ABSTRACT

A USB connection control apparatus and method and a data processing apparatus and method using the same, the USB connection control apparatus including a power controller to deactivate or activate a USB connection between a data storage device and an external device by blocking or supplying power to a USB client connecting the data storage device and the external device to each other, and a data processing unit to store data in the data storage device or to read data stored in the data storage device when the USB connection between the data storage device and the external device is deactivated.

### CROSS-REFERENCE TO RELATED APPLICATION

This application claims the benefit of Korean Patent Application No. -2006-045110, filed on May 19, 2006, in the Korean Intellectual Property Office, the disclosure of which is incorporated herein in its entirety by reference.

### BACKGROUND OF THE INVENTION

1. Field of the Invention

Aspects of the present invention relate to data processing, and more particularly, to a universal serial bus (USB) connection control apparatus and method and a data processing apparatus and method using the same.

2. Description of the Related Art

Data processing devices, such as MP3 players and portable media players (PMPs), can connect to a personal computer (PC) using a universal serial bus (USB). When a USB connection is achieved between a data processing device and a PC, the PC can access a data storage device included in the data processing device. In this case, the data processing device loses control of the data storage device. That is, the data processing device is recognized as a mass storage device and cannot perform any independent functions while maintaining a physical USB connection with the PC.

Thus, an apparatus and method to allow the data processing device to maintain control of the data storage device while maintaining a physical USB connection with the PC is required.

### SUMMARY OF THE INVENTION

Aspects of the present invention provide a USB connection control apparatus and method to allow a data processing device to maintain control of a data storage device while maintaining a physical USB connection with a PC, and a computer-readable recording medium storing a computer readable program to execute the USB connection control method.

Aspects of the present invention also provide a data processing apparatus and method using the USB connection control apparatus and method, and a computer-readable recording medium storing a computer-readable program to execute the data processing method.

According to an aspect of the present invention, there is provided a universal serial bus (USB) connection control apparatus comprising: a power controller to deactivate or to activate a USB connection between a data storage device and an external device by blocking or supplying power to a USB client connecting the data storage device to the external device; and a data processing unit to store data in the data storage device or to read data stored in the data storage device when the USB connection between the data storage device and the external device is deactivated.

The USB connection control apparatus may further comprise a user input unit to receive a signal instructing the power controller to deactivate or to activate the USB connection between the data storage device and the external device from a user.

The USB connection control apparatus may further comprise a use permission notification data determiner to determine whether data indicating that the USB connection control apparatus can use the data storage device is recorded by the external device in a use permission notification data recording area of the data storage device.

The external device may be a personal computer (PC) or a laptop computer.

The data storage device may be a hard disk drive or a flash memory.

According to another aspect of the present invention, there is provided a universal serial bus (USB) connection control method comprising: deactivating a USB connection between a data storage device and an external device by blocking power supplied to a USB client; storing data in the data storage device or reading data stored in the data storage device; and activating the USB connection between the data storage device and the external device by supplying power to the USB client.

The USB connection control method may further comprise: receiving a signal to deactivate the USB connection between the data storage device and the external device from a user; displaying to the user that the data has been stored in the data storage device or that the data stored in the data storage device has been read; and receiving a signal to activate the USB connection between the data storage device and the external device from the user.

The USB connection control method may be performed when data indicating that the USB connection control apparatus is allowed to use the data storage device is recorded by the external device in the data storage device.

According to yet another aspect of the present invention, there is provided a data processing apparatus comprising: a data storage device; a universal serial bus (USB) client connecting the data storage device to an external device; a power controller to deactivate or to activate a USB connection between the data storage device and the external device by blocking or supplying power to the USB client; and a data processing unit to store data in the data storage device or to read data stored in the data storage device when the USB connection between the data storage device and the external device is deactivated.

The data processing apparatus may be an MP3 player, a portable media player (PMP), or a personal digital assistant (PDA).

According to still another aspect of the present invention, there is provided a data processing method comprising: activating a universal serial bus (USB) connection between a data storage device and an external device through a USB cable; deactivating the USB connection between the data storage device and the external device by blocking power to a USB client; storing data in the data storage device or reading data stored in the data storage device; and activating the USB connection between the data storage device and the external device by supplying power to the USB client.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a USB connection control apparatus and a data processing apparatus using the same according to an embodiment of the present invention;

FIG. 2 is a flowchart illustrating a USB connection control method and a data processing method using the same according to an embodiment of the present invention;

FIG. 3 is a block diagram of a USB connection control apparatus according to another embodiment of the present invention;

FIG. 4 is a flowchart illustrating a USB connection control method and a data processing method using the same according to another embodiment of the present invention;

FIG. 5 is a block diagram of a USB connection control apparatus and a data processing apparatus using the same according to still another embodiment of the present invention; and

FIG. 6 is a flowchart illustrating a USB connection control method and a data processing method using the same according to still another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

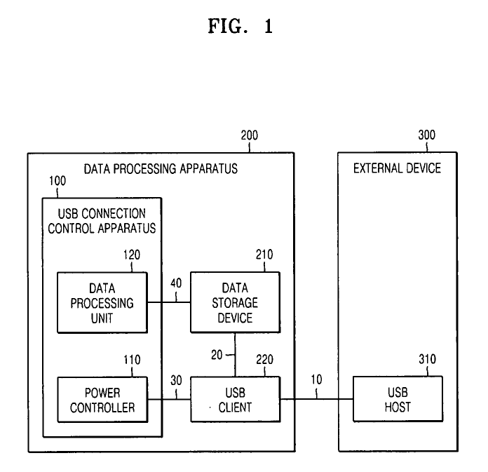

FIG. 1 is a block diagram of a universal serial bus (USB) connection control apparatus 100 and a data processing apparatus 200 using the same according to an embodiment of the present invention.

Referring to FIG. 1, the USB connection control apparatus 100 may include a power controller 110 and a data processing unit 120. The data processing apparatus 200 may include the USB connection control apparatus 100, a data storage device 210, and a USB client 220. For ease of description, an external device 300 connected to the data processing apparatus 200 through a USB connection 10 is also shown in FIG. 1.

The data storage device 210 stores data processed by the data processing apparatus 200. It is understood that, according to an aspect, the data processing apparatus 200 may be a multimedia content player, such as an MP3 player, a portable media player (PMP), or a personal digital assistant (PDA). However, the data processing apparatus 200 is not limited thereto, and may be any device communicating data with the external device 300 through a USB connection 10. In addition, it is understood that the data storage device 210 may be a hard disk drive or a flash memory. However, the data storage device 210 is not limited thereto, and may be any device from or to which the data processing apparatus 200 and the external device 300 can read or record data.

Furthermore, the external device 300 may be a computer, such as a personal computer (PC) or a laptop computer. However, it is understood that the external device 300 is not limited thereto, and may be any device communicating data with the data processing apparatus 200.

The USB client 220 establishes a USB connection 10 between the data processing apparatus 200 and the external device 300. In detail, the USB client 220 connects the data storage device 210 included in the data processing apparatus 200 to the external device 300.

The external device 300 includes a USB host 310 for the USB connection 10. In detail, when the USB connection 10 is established, data transmission is performed between the USB client 220 and the USB host 310. The USB client 220 transmits data stored in the data storage device 210 to the USB host 310 or transmits data received from the USB host 310 to the data storage device 210. The USB host 310 transmits data received from the USB client 220 to a controller (not shown) included in the external device 300 or transmits data received from the controller included in the external device 300 to the USB client 220.

Hereinafter, when describing data transmission and reception with the external device 300 via the USB host 310, it is assumed that the data transmission and reception is directly performed with the external device 300 without describing the USB host 310. Thus, for example, when the USB client 220 establishes the USB connection 10 between the data storage device 210 and the external device 300, description of the USB host 310 is omitted.

The power controller 110 deactivates or activates the USB connection 10 and/or a connection 20 between the data storage device 210 and the external device 300 by blocking or supplying power 30 to the USB client 220.

Through a connection 40 between the data processing unit 120 and the data storage device 210, the data processing unit 120 stores data in the data storage device 210 or reads data stored in the data storage device 210 when the USB connection 10 and/or the connection 20 between the data storage device 210 and the external device 300 is deactivated.

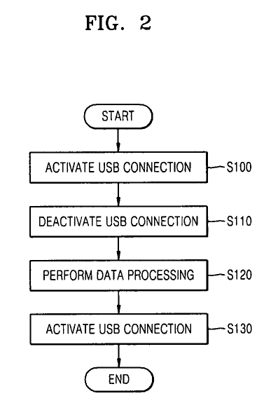

Operations of the power controller 110 and the data processing unit 120 will now be described in detail with reference to FIG. 2.

FIG. 2 is a flowchart illustrating a USB connection control method and a data processing method using the same according to an embodiment of the present invention. Referring to FIG. 2, the USB connection 10 between the data processing apparatus 200 and the external device 300 is activated in operation S100.

A physical USB connection 10 may be a USB cable connection or a wireless USB connection. In the USB cable connection, the data processing apparatus 200 and the external device 300 are connected using a USB cable. For the USB cable connection, the USB cable is connected to a USB port. In the wireless USB connection, the data processing apparatus 200 and the external device 300 are connected using a USB dongle. A USB dongle is a device that allows a product to perform wireless functions through, for example, a USB port. The USB dongle can be attached to the USB port of the data processing apparatus 200 or can be included in the data processing apparatus 200.

When the USB connection 10 is activated, control of the data storage device 210 is transferred to the external device 300 from the data processing apparatus 200. That is, the data storage device 210 is disconnected from the data processing apparatus 200 and connected to the external device 300.

Thus, while the physical USB connection between the data processing apparatus 200 and the external device 300 is being maintained, the data processing apparatus 200 cannot perform its original functions and only operates as a mass storage device.

In operation S110, the data processing apparatus 200 deactivates the USB connection 10 therefore enabling the data processing apparatus 200 to take control of the data storage device 210. To deactivate the USB connection 10 while maintaining the physical USB connection between the data processing apparatus 200 and the external device 300, the power controller 110 blocks power 30 to the USB client 220. As a result, the USB connection 10 between the data storage device 210 and the external device 300 is logically disconnected. That is, the external device 300 recognizes that the USB connection 10 is disconnected. In a case of the USB cable connection, the external device 300 recognizes that the USB cable is unplugged from the USB port. Thus, even though the physical USB connection is maintained, a state where the USB connection 10 is logically disconnected can be generated. The data processing apparatus 200 regains control of the data storage device 210. Thus, the data processing apparatus 200 can have control of the data storage device 210 even while maintaining the physical USB connection between the data processing apparatus 200 and the external device 300.

In operation S120, the data processing unit 120 performs data processing of the data storage device 210 in a state where the USB connection 10 between the data processing apparatus 200 and the external device 300 is logically disconnected. Specifically, the data processing unit 120 stores data in the data storage device 210 and/or reads data stored in the data storage device 210. In this case, the data processing apparatus 200 may perform the same functions as if there were not a physical USB connection with the external device 300

In operation S130, the USB connection 10 between the data processing apparatus 200 and the external device 300 is activated again after completing the data processing. Since the physical USB connection with the external device 300 is already established, only a logical USB connection is established here. To achieve a normal physical USB connection again, the power controller 110 supplies the power 30 to the USB client 220 again. When the power 30 is supplied to the USB client 220 again, the USB client 220 performs USB connection procedures performed when the physical USB connection is first established. By doing this, the data processing apparatus 200 and the external device 300 enter the same state as when the USB connection 10 is activated in operation S100. That is, the USB connection 10 between the data storage device 210 and the external device 300 is activated, and the data processing apparatus 200 loses control of the data storage device 210. The external device 300 recognizes the data processing apparatus 200 as a mass storage device again.

Logical connection or disconnection of the USB connection 10 can be controlled by a user or the USB connection control apparatus 100.

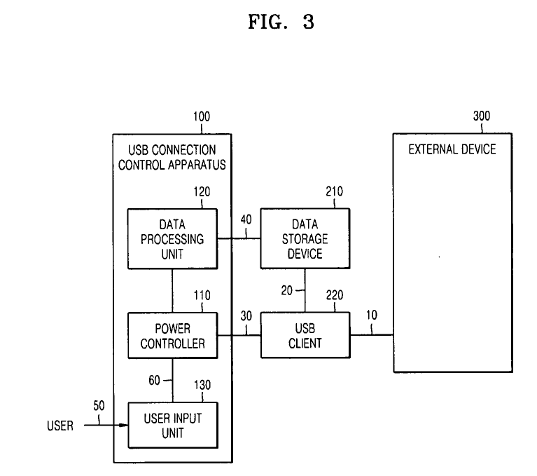

FIG. 3 is a block diagram of the USB connection control apparatus 100 according to another embodiment of the present invention. The USB connection control apparatus 100, as illustrated in FIG. 3, also includes a user input unit 130 to allow a user to logically connect or disconnect the USB connection 10.

Since the USB connection control apparatus 100, the power controller 110, the data processing unit 120, the data storage device 210, the USB client 220, and the external device 300, which are illustrated in FIG. 3, are the same as, respectively, the USB connection control apparatus 100, the power controller 110, the data processing unit 120, the data storage device 210, the USB client 220, and the external device 300, which are illustrated in FIG. 1, a description thereof will be omitted.

The user input unit 130 receives a signal 50 to deactivate or activate a logical USB connection from the user. An input module (not shown) of the data processing apparatus 200 can be used as the user input unit 130. In a case of a PDA, a specific key of a keyboard can be assigned as a key to deactivate or activate the logical USB connection. In addition, the user input unit 130 can be realized using separate input modules. For example, the user input unit 130 can be realized using a USB connection deactivation button and a USB connection activation button. In addition, the user input unit 130 can be realized using a button to temporarily recover functions of the data processing apparatus 200. It is understood that the user input unit 130 is not limited thereto, and may be realized by any device or method that receives an input from a user.

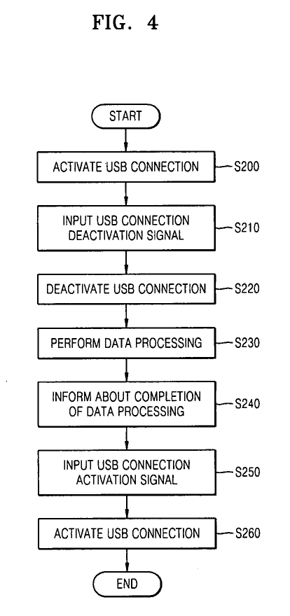

FIG. 4 is a flowchart illustrating a USB connection control method and a data processing method using the same according to another embodiment of the present invention. Referring to FIG. 4, the USB connection 10 between the data processing apparatus 200 and the external device 300 is activated in operation S200. The external device 300 can access the data storage device 210 through the USB connection 10, and the data processing apparatus 200 loses control of the data storage device 210. Thus, the user cannot use original functions of the data processing apparatus 200.

For the user to use the original functions of the data processing apparatus 200, the data processing apparatus 200 must regain control of the data storage device 210 by deactivating the USB connection 10.

When the USB connection control apparatus 100is not used, the user must physically remove the USB connection 10 to deactivate the USB connection 10. In a case of a USB cable connection, the user must unplug a USB cable from a USB port. In a case of a wireless USB connection, the user must unplug a USB dongle from the USB port. However, the USB connection control apparatus 100 does not require the user to remove a physical USB connection.

In operation S210, the user inputs the signal 50 to deactivate the USB connection 10 using the user input unit 130 in order to disconnect the logical USB connection while maintaining the physical USB connection. The user input unit 130 informs, via a signal 60, the power controller 110 of the input signal 50.

In operation S220, the power controller 110 logically deactivates the USB connection 10 between the data storage device 210 and the external device 300 by blocking the power 30 supplied to the USB client 220.

By deactivating the USB connection 10, the data processing apparatus 200 regains control of the data storage device 210, and the user can thereby perform data processing using the original functions of the data processing apparatus 200 in operation S230.

When the data processing functions of storing data in the data storage device 210 and/or reading data stored in the data storage device 210 are completed, the data processing apparatus 200 informs the user in operation S240 that the data processing has been completed. According to an aspect, the data processing apparatus 200 informs the user that the data processing has been completed through a message, such as an instruction to the user to input a signal 50 to activating the USB connection 10. However, it is understood that the method of informing the user is not limited thereto, and any method of informing the user, such as terminating a program executed by the user, may be used.

In operation S250, the user inputs the signal 50 to activate the USB connection 10 after determining the completion of the data processing. The user input unit 130 transmits the received USB connection activation signal 50 to the power controller 110.

In operation S260, the power controller 110 activates the USB connection 10 by supplying power 30 to the USB client 220.

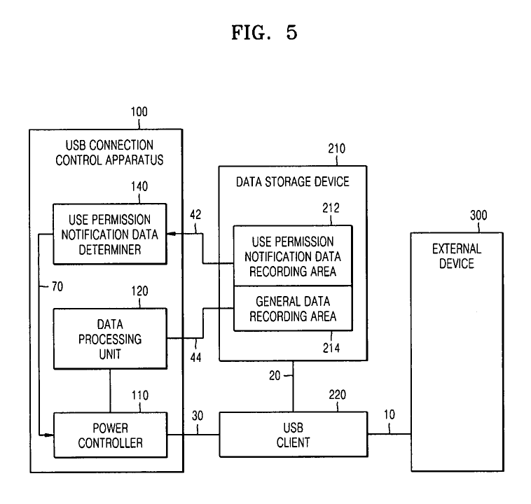

FIG. 5 is a block diagram of the USB connection control apparatus 100 and the data processing apparatus 200 using the same according to still another embodiment of the present invention. The USB connection control apparatus 100, as illustrated in FIG. 5, also includes a use permission notification data determiner 140.

In FIG. 5, the data storage device 210 includes a general data recording area 214 and a use permission notification data recording area 212. The use permission notification data recording area 212 is a specific area of the data storage device 210 in which the external device 300 records use permission notification data.

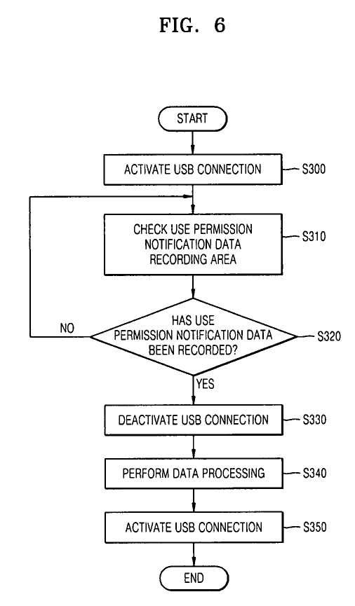

The use permission notification data indicates that the external device 300 permits the USB connection control apparatus 100 or the data processing apparatus 200 use of the data storage device 210 by transferring control of the data storage device 210 to the USB connection control apparatus 100 or the data processing apparatus 200. Operations of the USB connection control apparatus 100 and the data processing apparatus 200 using the use permission notification data according to the current embodiment will now be described in detail with reference to FIG. 6.

FIG. 6 is a flowchart illustrating a USB connection control method and a data processing method using the same according to still another embodiment of the present invention. FIG. 6 shows a case where the use permission notification data is used.

Referring to FIG. 6, the USB connection 10 between the data processing apparatus 200 and the external device 300 is activated in operation S300. The data processing apparatus 200 loses control of the data storage device 210. However, the USB connection control apparatus 100 or the data processing apparatus 200 can read the use permission notification data recording area 212 included in the data storage device 210.

The use permission notification data indicates that the external device 300 permits the data processing apparatus 200 use of the data storage device 210. A format, including for example size and content, of the use permission notification data may vary according to an aspect.

For the use permission notification data, a value (“0” or “1”) of one byte or bit can be used. For example, a one-byte area of the data storage device 210 can be assigned as the use permission notification data recording area 212. When the USB connection 10 between the data processing apparatus 200 and the external device 300 is activated, a value, such as “0,” is recorded in the use permission notification data recording area 212 as an initial value.

After the USB connection 10 between the data processing apparatus 200 and the external device 300 is activated, the use permission notification data determiner 140 continuously checks the value of the use permission notification data recording area 212 included in the data storage device 210 in operation S310.

Once the external device 300 completes data processing of data in the data storage device 210, the external device 300 stores the use permission notification data in the use permission notification data recording area 212 of the data storage device 210 in order to transfer control of the data storage device 210 to the data processing apparatus 200. In the case of using a one-byte value as the use permission notification data, the external device 300 stores, for example, a value of “1” in the use permission notification data recording area 212.

In operation S320, the use permission notification data determiner 140 determines whether the value “1” is recorded as the use permission notification data. When the external device 300 records the value “1” as the use permission notification data, the use permission notification data determiner 140 informs, via a signal 70, the power controller 110 that the value “1” has been recorded as the use permission notification data.

In operation S330, the power controller 110 logically deactivates the USB connection 10 by blocking the power 30 supplied to the USB client 220. In operation S340, the data processing unit 120 performs data processing to store data in the general data recording area 214 of the data storage device 210 and/or to read data stored in the general data recording area 214.

After the data processing is completed, the power controller 110 activates the USB connection 10 by supplying the power 30 to the USB client 220 in operation S350.

Aspects of the present invention can be used to implement shared file communication. The external device 300 and the data processing apparatus 200, as illustrated in FIG. 5, can use the data storage device 210 to transmit and receive a specific file. For example, the external device 300 may transmits a video file named A to the data processing apparatus 200 and the data processing apparatus 200 may performs specific data processing thereon. After the USB connection 10 is activated in operation S300, the external device 300 records the file A in the general data recording area 214 of the data storage device 210 and stores the use permission notification data (such as the value “1”) in the use permission notification data recording area 212.

If the use permission notification data determiner 140 determines in operation S320 that the use permission notification data having the value “1” has been recorded, the power controller 110 deactivates the USB connection 10 in operation S330.

The data processing unit 120 performs data processing of the file A recorded in the general data recording area 214 in operation S340. If the data processing of the file A is completed, the power controller 110 activates the USB connection 10 in operation S350, and the external device 300 reads the data processed file A from the general data recording area 214.

As described above, by using the USB connection control method according to an aspect of the present invention, the shared file communication between the external device 300 and the data processing apparatus 200 can be easily implemented.

Aspects of the invention can also be embodied as computer-readable codes on a computer-readable recording medium. The computer-readable recording medium is any data storage device that can store data which can be thereafter read by a computer system or any device that has an information processing function. Examples of the computer-readable recording medium include read-only memory (ROM), random-access memory (RAM), CD-ROMs, magnetic tapes, floppy disks, and optical data storage devices.

As described above, in a USB connection control apparatus and method and a data processing apparatus and method using the same, according to aspects of the present invention, since a USB connection can be logically disconnected while maintaining a physical USB connection by deactivating or activating the USB connection by blocking or supplying power to a USB client, a user is provided the convenience of not having to remove the physical USB connection. In addition, since the USB connection can be deactivated or activated without an operation of the user by using use permission notification data, shared file communication can be easily implemented.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A universal serial bus (USB) connection control apparatus comprising:
a power controller to deactivate a USB connection, while maintaining a physical USB connection, between a data storage device and an external device by blocking power to a USB client connecting the data storage device to the external device; and
a data processing unit to store data in the data storage device or to read data stored in the data storage device when the USB connection between the data storage device and the external device is deactivated.

2. The USB connection control apparatus as claimed in claim 1, wherein the power controller activates the USB connection between the data storage device and the external device by supplying power to the USB client.

3. The USB connection control apparatus as claimed in claim 1, further comprising:
a user input unit to receive a signal instructing the power controller to deactivate the USB connection between the data storage device and the external device from a user.

4. The USB connection control apparatus as claimed in claim 3, wherein:
the power controller activates the USB connection between the data storage device and the external device by supplying power to the USB client; and
the user input unit receives a signal instructing the power controller to activate the USB connection between the data storage device and the external device from the user.

5. The USB connection control apparatus as claimed in claim 1, further comprising:
a use permission notification data determiner to determine whether use permission notification data indicating that the USB connection control apparatus is enabled to use the data storage device is recorded by the external device in a use permission notification data recording area of the data storage device.

6. The USB connection control apparatus as claimed in 5, wherein:
the external device records the use permission notification data with a first value in the use permission notification data recording area to indicate that the USB connection control apparatus is not enabled to use the data storage device; and
the external device records the use permission notification data with a second value in the use permission notification data recording area to indicate that the USB connection control apparatus is enabled to use the data storage device.

7. The USB connection control apparatus as claimed in 6, wherein the external device records the use permission notification data with the first value when the USB connection between the data storage device and the external device is activated.

8. The USB connection control apparatus as claimed in 6, wherein the external device records the use permission notification data with the second value when the external device completes a data processing operation on the data storage device.

9. The USB connection control apparatus as claimed in 5, wherein the use permission notification data determiner instructs the power controller to deactivate the USB connection between the data storage device and the external device when the use permission notification data determiner determines that the use permission notification data indicating that the USB connection control apparatus is enabled to use the data storage device is recorded by the external device in the use permission notification data recording area of the data storage device.

10. The USB connection control apparatus as claimed in claim 1, wherein the external device is a personal computer (PC) or a laptop computer.

11. The USB connection control apparatus as claimed in claim 1, wherein the data storage device is a hard disk drive or a flash memory.

12. The USB connection control apparatus as claimed in claim 1, wherein the USB connection control apparatus is provided in an MP3 player, a portable media player (PMP), or a personal digital assistant (PDA).

13. A universal serial bus (USB) connection control method comprising:
deactivating a USB connection, while maintaining a physical USB connection, between a data storage device and an external device by blocking power supplied to a USB client; and
storing data in the data storage device or reading data stored in the data storage device.

14. The USB connection control method as claimed in claim 13, further comprising:
activating the USB connection between the data storage device and the external device by supplying power to the USB client.

15. The USB connection control method as claimed in claim 13, further comprising:
receiving a signal to deactivate the USB connection between the data storage device and the external device from a user.

16. The USB connection control method as claimed in claim 15, further comprising:
outputting a message to the user indicating that the data has been stored in the data storage device or that the data stored in the data storage device has been read.

17. The USB connection control method as claimed in claim 15, further comprising:
receiving a signal to activate the USB connection between the data storage device and the external device from the user; and
activating the USB connection between the data storage device and the external device by supplying power to the USB client.

18. The USB connection control method as claimed in claim 13, further comprising:
determining whether use permission notification data indicating that the USB connection is enabled to be deactivated is recorded by the external device in a use permission notification data recording area of the data storage device, wherein
the deactivating of the USB connection is performed when the use permission notification data is determined to indicate that the USB connection is enabled to be deactivated.

19. The USB connection control method as claimed in claim 18, wherein the determining of whether use permission notification data indicating that the USB connection is enabled to be deactivated is recorded comprises:
determining that the USB connection is not enabled to be deactivated when the external device records the use permission notification data with a first value in the use permission notification data recording area; and
determining that the USB connection is enabled to be deactivated when the external device records the use permission notification data with a second value in the use permission notification data recording area.

20. The USB connection control method as claimed in claim 19, wherein the external device records the use permission notification data with the first value when the USB connection is activated.

21. The USB connection control method as claimed in claim 19, wherein the external device records the user permission notification data with the second value when the external device completes a data processing operation on the data storage device.

22. The USB connection control method as claimed in claim 13, wherein the external device is a personal computer (PC) or a laptop computer.

23. The USB connection control method as claimed in claim 13, wherein the data storage device is a hard disk drive or a flash memory.

24. A data processing apparatus comprising:
a data storage device to store data;
a universal serial bus (USB) client to connect the data storage device to an external device;
a power controller to deactivate a USB connection between the data storage device and the external device by blocking power to the USB client; and
a data processing unit to store data in the data storage device or to read data stored in the data storage device when the USB connection between the data storage device and the external device is deactivated.

25. The data processing apparatus as claimed in claim 24, wherein the power controller activates the USB connection between the data storage device and the external device by supplying power to the USB client.

26. The data processing apparatus as claimed in claim 24, further comprising:
a user input unit to receive a signal instructing the power controller to deactivate the USB connection between the data storage device and the external device from a user.

27. The data processing apparatus as claimed in claim 26, wherein:
the power controller activates the USB connection between the data storage device and the external device by supplying power to the USB client; and
the user input unit receives a signal instructing the power controller to activate the USB connection between the data storage device and the external device from the user.

28. The data processing apparatus as claimed in claim 24, further comprising:
a use permission notification data determiner to determine whether use permission notification data indicating that the data processing apparatus is enabled to use the data storage device is recorded by the external device in a use permission notification data recording area of the data storage device.

29. The USB connection control apparatus as claimed in 28, wherein:
the external device records the use permission notification data with a first value in the use permission notification data recording area to indicate that the USB connection control apparatus is not enabled to use the data storage device; and
the external device records the use permission notification data with a second value in the use permission notification data recording area to indicate that the USB connection control apparatus is enabled to use the data storage device.

30. The USB connection control apparatus as claimed in 29, wherein the external device records the use permission notification data with the first value when the USB connection between the data storage device and the external device is activated.

31. The USB connection control apparatus as claimed in 29, wherein the external device records the use permission notification data with the second value when the external device completes a data processing operation on the data storage device.

32. The USB connection control apparatus as claimed in 28, wherein the use permission notification data determiner instructs the power controller to deactivate the USB connection between the data storage device and the external device when the use permission notification data determiner determines that the use permission notification data indicating that the USB connection control apparatus is enabled to use the data storage device is recorded by the external device in the use permission notification data recording area of the data storage device.

33. The data processing apparatus as claimed in claim 24, wherein the external device is a personal computer (PC) or a laptop computer.

34. The data processing apparatus as claimed in claim 24, wherein the data storage device is a hard disk drive or a flash memory.

35. The data processing apparatus as claimed in claim 24, wherein the data processing apparatus is an MP3 player, a portable media player (PMP), or a personal digital assistant (PDA).

36. A data processing method comprising:
activating a universal serial bus (USB) connection between a data storage device and an external device;
deactivating the USB connection between the data storage device and the external device by blocking power to a USB client;
storing data in the data storage device or reading data stored in the data storage device; and
activating the USB connection between the data storage device and the external device by supplying power to the USB client.

37. The data processing method as claimed in claim 36, further comprising:
receiving a signal to deactivate the USB connection between the data storage device and the external device from a user.

38. The data processing method as claimed in claim 37, further comprising:
outputting a message to the user indicating that the data has been stored in the data storage device or that the data stored in the data storage device has been read.

39. The data processing method as claimed in claim 37, further comprising:
receiving a signal to activate the USB connection between the data storage device and the external device from the user.

40. The data processing method as claimed in claim 36, further comprising:
determining whether use permission notification data indicating that the USB connection is enabled to be deactivated is recorded by the external device in a use permission notification data recording area of the data storage device, wherein
the deactivating of the USB connection between the data storage device and the external device is performed when the use permission notification data is determined to indicate that the USB connection is enabled to be deactivated.

41. The data processing method as claimed in claim 36, wherein the external device is a personal computer (PC) or a laptop computer.

42. The data processing method as claimed in claim 36, wherein the data storage device is a hard disk drive or a flash memory.

43. The data processing method as claimed in claim 36, wherein the activating of the USB connection comprises:
activating the USB connection through a USB cable.

44. A universal serial bus (USB) connection control apparatus comprising:
a power controller to deactivate a USB connection between a data storage device and an external device by blocking power to a USB client connecting the data storage device to the external device.

45. The USB connection control apparatus as claimed in claim 44, further comprising:
a data processing unit to store data in the data storage device or to read data stored in the data storage device when the USB connection between the data storage device and the external device is deactivated.

46. The USB connection control apparatus as claimed in claim 44, further comprising:
a user input unit to receive a signal instructing the power controller to deactivate the USB connection between the data storage device and the external device from a user.

47. The USB connection control apparatus as claimed in claim 44, further comprising:
a use permission notification data determiner to determine whether use permission notification data indicating that the USB connection control apparatus is enabled to use the data storage device is recorded by the external device in a use permission notification data recording area of the data storage device.

48. A computer-readable recording medium encoded with the method of claim 13 implemented by a computer.

49. A computer-readable recording medium encoded with the method of claim 36 implemented by a computer.
